(19) United States
(12) Patent Application Publication
(10) Pub. No.: US 2025/0214645 A1
(43) Pub. Date: Jul. 3, 2025

(54) INDEPENDENT STEERING DEVICE HAVING A REDUCER AND A MOTOR, AND A VEHICLE INCLUDING THE SAME

(71) Applicants: HYUNDAI MOTOR COMPANY, Seoul (KR); KIA CORPORATION, Seoul (KR); SEOHAN INNOBILITY CO., LTD., Chungcheongbuk-do (KR)

(72) Inventors: Jin Ho Bae, Suwon-si (KR); Hyeong Seop Park, Hwaseong-si (KR); Chang Seop An, Incheon (KR); Min Sang Seong, Yongin-si (KR); Jae Geun Bang, Hwaseong-si (KR); Jung Min Cho, Hwaseong-si (KR); Seong Kweon Joo, Hwaseong-si (KR)

(73) Assignees: HYUNDAI MOTOR COMPANY, Seoul (KR); KIA CORPORATION, Seoul (KR); SEOHAN INNOBILITY CO., LTD., Chungcheongbuk-do (KR)

(21) Appl. No.: 18/733,108

(22) Filed: Jun. 4, 2024

(30) Foreign Application Priority Data
Dec. 27, 2023 (KR) 10-2023-0192491

(51) Int. Cl. B62D 5/04; B62D 7/18

(52) U.S. Cl. CPC B62D 5/0418; B62D 5/0403; B62D 5/0442; B62D 7/18

(57) ABSTRACT

An independent steering device includes: a knuckle coupled to a wheel; and a driving unit having the knuckle rotatably coupled to at least a portion thereof and providing a driving force for rotating the knuckle. The driving unit may include: a motor having a first rotating shaft; a reducer having a second rotating shaft and coupled to the knuckle; and a power transmission member connecting the first rotating shaft and the second rotating shaft and configured to transmit rotational force between the first rotating shaft and the second rotating shaft. The motor and the reducer may be disposed so that the first and second rotating shafts are parallel.

### CROSS-REFERENCE TO RELATED APPLICATION(S)

This application claims benefit of and priority to Korean Patent Application No. 10-2023-0192491, filed on Dec. 27, 2023, in the Korean Intellectual Property Office, the disclosure of which is incorporated herein by reference in its entirety.

### BACKGROUND

### 1. Field

The present disclosure relates to an independent steering device having a parallel arrangement structure of a reducer and a motor, and a vehicle including the same.

### 2. Description of Related Art

In general, a power steering system has a problem in that it has a complex configuration such as a pump, a gearbox, that also serves as a power cylinder, and piping. These complexities make it difficult to precisely control steering assist force. Additionally, power steering may not operate when oil leaks. Moreover, any malfunctions in the operation of a steering device may lead to the dependent control of both left and right wheels, rendering vehicle steering control impossible and danger.

In addition, small vehicle devices having various concepts are being developed. A corner module in which steering, suspension, and braking are combined may be applied to a small vehicle device, but there is a limitation in that the motor may protrude from the wheels or above a vehicle floor, and thus, may negatively take up interior space.

The statements in this section merely provide background information related to the present disclosure and may not constitute prior art.

### SUMMARY

To solve the aforementioned problems, a method of implementing independent steering for each vehicle wheel by applying an electric steering device using a motor to enable steering and precise control of the assist force with a simple configuration is provided.

An aspect of the present disclosure may provide a steering device that is easy to apply to a low-floor platform by arranging a motor and a reducer in parallel so that each rotating shaft is parallel, to shorten a length of the steering device, and a vehicle including the same.

According to an aspect of the present disclosure, an independent steering device may include: a knuckle coupled to a wheel; and a driving unit having the knuckle rotatably coupled to at least a portion thereof and providing driving force for rotating the knuckle. The driving unit may include: a motor having a first rotating shaft; a reducer having a second rotating shaft and coupled to the knuckle; and a power transmission member connecting the first rotating shaft and the second rotating shaft and configured to transmit a rotational force between the first rotating shaft and the second rotating shaft. The motor and the reducer may be disposed so that the first rotating shaft and the second rotating shaft are parallel.

The driving unit may further include a bracket to which the motor and the reducer are coupled. The bracket may include a first part to which the motor is coupled, and a second part extending from the first part and coupled to the reducer.

The motor and the reducer may be coupled to a lower surface of the bracket. The first rotating shaft and the second rotating shaft may penetrate through the bracket and may be positioned on an upper surface of the bracket. The power transmission member may be connected to the first rotating shaft and the second rotating shaft on the upper surface of the bracket.

The bracket may be formed in a plate shape. The first rotating shaft and the second rotating shaft may respectively protrude from the upper surface of the bracket by a predetermined length and may be disposed in parallel at a predetermined distance.

The power transmission member may include: a first pulley that is coupled to the first rotating shaft, a second pulley that is coupled to the second rotating shaft, and a belt connecting the first pulley and the second pulley. A rotational motion of the first rotating shaft may be decelerated at a predetermined reduction ratio by the power transmission member.

The reducer may further include a housing that is fixed to the bracket, and an output unit that is at least partially disposed inside the housing and rotates with respect to the housing in conjunction with rotation of the second rotating shaft. The knuckle may be connected to the output unit so as to rotate integrally with the output unit.

The reducer may decelerate a rotational motion of the second rotating shaft at a predetermined reduction ratio and output the rotational motion through the output unit.

The knuckle may rotate relatively with respect to the housing of the reducer. When the knuckle rotates, the positions of the housing, the motor, and the bracket of the reducer may be fixed.

The reducer may be a harmonic drive reducer.

The reducer may further include: an input unit having an inner ring connected to the second rotating shaft and formed of an oval; and an external ring elastically deformed to protrude in a major axis direction by rotation of the inner ring via a plurality of balls provided on an external side of the inner ring. The reducer may further include a fixing portion fixed to the bracket together with the housing and provided with internal teeth formed on an inner side surface thereof. The output unit is inserted into the fixing portion. The input unit is coupled to an inner side of the output unit, and the output unit is provided with external teeth formed on an external side surface thereof and configured to be elastically deformed based on deformation of the external ring of the input unit. The external teeth of the output unit correspond to the internal teeth of the fixing portion.

The driving unit may be coupled to a vehicle body through a connection member. The reducer may include a coupling portion, formed on an external side surface of the reducer, and may be coupled to the connection member.

According to another aspect of the present disclosure, a vehicle may include: a vehicle body; a wheel mounted on the vehicle body; and a steering device connecting the vehicle body, the wheel, and a steering the wheel. The steering device may include: a knuckle coupled to a wheel; and a driving unit having the knuckle rotatably coupled to at least a portion thereof and providing driving force for rotating the knuckle. The driving unit may include: a motor having a first rotating shaft, a reducer having a second rotating shaft and is coupled to the knuckle; and a power transmission member connecting the first rotating shaft and the second rotating shaft. The power transmission member may be configured to transmit a rotational force between the first rotating shaft and the second rotating shaft, and the motor and the reducer may be disposed so that the first and second rotating shafts are parallel.

The vehicle may further include a connection member connecting the steering device and the vehicle body. The connection member may include a first connection member connecting the reducer and the vehicle body and a second connection member connecting the knuckle and the vehicle body. The first connection member may be positioned above the second connection member.

An upper end portion of the knuckle may be coupled to the reducer. A lower end portion of the knuckle may be coupled to the second connection member. The second connection member may be rotatably coupled to the lower end portion of the knuckle.

The reducer may include a coupling portion, formed on an external side surface of the reducer, and may be configured to be coupled to the second connection member.

As the reducer may be coupled to the vehicle body through the second connection member, a relative position and attitude of the driving unit with respect to the vehicle body may be fixed when the knuckle rotates.

A gap may be formed between the wheel and the vehicle body to secure a steering angle of the wheel to a predetermined angle. The steering device may be provided in a space formed by the gap to be positioned between the wheel and the vehicle body.

The driving unit may further include a bracket to which the motor and the reducer are coupled. The bracket may include a first part to which the motor is coupled and a second part extending from the first part and coupled to the reducer.

The motor and the reducer may be coupled to a lower surface of the bracket. The first rotating shaft and the second rotating shaft may penetrate through the bracket and may be positioned on an upper surface of the bracket. The power transmission member may be connected to the first rotating shaft and the second rotating shaft on the upper surface of the bracket.

The reducer may be a harmonic drive reducer.

### BRIEF DESCRIPTION OF DRAWINGS

The above and other aspects, features, and advantages of the present disclosure should be more clearly understood from the following detailed description taken in conjunction with the accompanying drawings, in which:

FIG. 1 is a perspective view illustrating a vehicle to which a steering device according to an embodiment in the present disclosure is applied;

FIG. 2 is a diagram illustrating a connection structure between a steering device and a body of a vehicle according to the embodiment in the present disclosure;

FIG. 3 is a perspective view illustrating a structure in which a wheel, a steering device, a connection member, and a body of a vehicle according to the embodiment in the present disclosure are connected;

FIG. 4 is a front view illustrating a structure in which a wheel, a steering device, a connection member, and a body of a vehicle according to the embodiment in the present disclosure are connected;

FIG. 5 is a top plan view illustrating a structure in which a wheel, a steering device, a connection member, and a body of a vehicle according to the embodiment in the present disclosure are connected;

FIG. 6 is an exploded perspective view illustrating a state in which a steering device according to the embodiment in the present disclosure is disassembled from a wheel;

FIG. 7 is an exploded perspective view illustrating the state in which a steering device according to the embodiment in the present disclosure is disassembled;

FIG. 8 is a cross-sectional view illustrating the state in which a steering device according to the embodiment in the present disclosure is coupled;

FIG. 9 is a diagram illustrating an operation in which a wheel is rotated by a steering device in a vehicle according to the embodiment in the present disclosure; and

FIG. 10 is a diagram schematically illustrating a system for controlling a steering device of a vehicle according to an embodiment in the present disclosure.

### DETAILED DESCRIPTION

The present disclosure may be variously modified and have several embodiments. Therefore, specific embodiments of the present disclosure should be illustrated in the accompanying drawings and be described in detail below. However, it should be understood that the present disclosure is not limited to a specific embodiment, but includes all modifications, equivalents, and substitutions without departing from the scope and spirit of the present disclosure.

Terms used in the specification, such as ‘first,’ ‘second,’ and the like, may be used to describe various components, but the components are not to be interpreted to be limited to the terms. The terms are used only to distinguish one component from another component. For example, a first component may be named a second component and the second component may also be similarly named the first component, without departing from the scope of the present disclosure. The term and/or includes a combination of a plurality of related described items or any one of the plurality of related described items.

Terms used in the present specification are used only in order to describe specific embodiments rather than limiting the present disclosure. Singular forms are intended to include plural forms unless the context clearly indicates otherwise. It should be further understood that the terms “comprises” or “have” used in this specification, specify the presence of stated features, steps, operations, components, parts mentioned in this specification, or a combination thereof, but do not preclude the presence or addition of one or more other features, numerals, steps, operations, components, parts, or a combination thereof.

Unless indicated otherwise, it should be understood that all the terms used in the specification including technical and scientific terms have the same meaning as those that are generally understood by those having ordinary skilled in the art. Terms generally used and defined by a dictionary should be interpreted as having the same meanings as meanings within a context of the related art and should not be interpreted as having ideal or excessively formal meanings unless being clearly defined otherwise in the present specification.

When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, embodiments of the present disclosure are described with reference to the drawings.

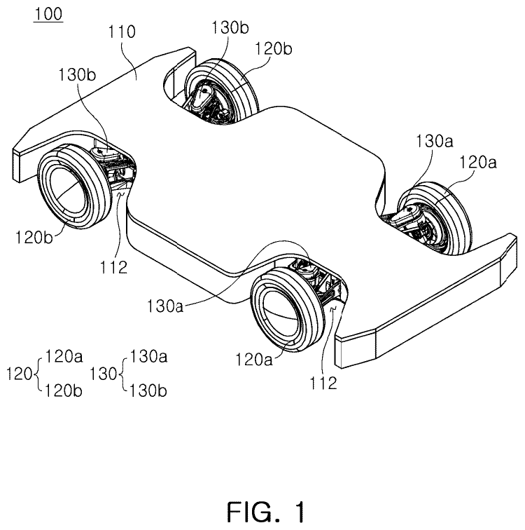

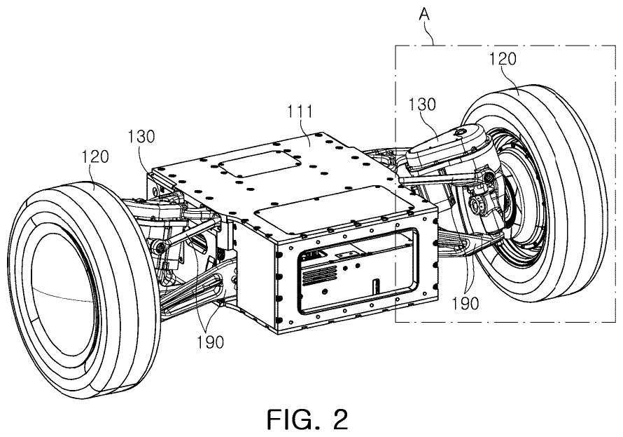

FIG. 1 is a perspective view illustrating a vehicle 100 to which a steering device 130 according to an embodiment in the present disclosure is applied. FIG. 2 is a diagram illustrating a connection structure between the steering device 130 and a body 110 of the vehicle 100 according to an embodiment in the present disclosure.

The steering device 130 according to an embodiment in the present disclosure is a vehicle steering device applied to the vehicle 100. The vehicle 100 refers to various vehicles that move objects such as people, animals, and goods from an origin to a destination. The vehicle is not limited to vehicles that drive on roads or tracks.

The steering device 130 according to an embodiment may be provided in a structure in which it may be connected to a plurality of wheels 120 provided in the vehicle 100, respectively, to independently steer each wheel 120 and secure a steering angle of the wheel 120 up to about 90°.

Referring to FIGS. 1 and 2, the vehicle 100 according to an embodiment may include the body 110, the wheel 120, the steering device 130, and a connection member 190.

The vehicle 100 illustrated in FIG. 1 is schematically illustrated, and the components included in the vehicle 100 are not necessarily limited to the components illustrated. Additionally, according to various embodiments, the vehicle 100 may further include other components.

The body 110 may have a structure in which the wheel 120, the steering device 130, and the connection member 190 are coupled and mounted. The body 110 may be moved and adjusted in any direction by driving the wheel 120 and the steering device 130. One side of the connection member 190 may be fixed to the body 110, and the steering device 130 and the wheel 120 may be connected to the other side of the connection member 190 and mounted on the body 110.

The body 110 may include a chassis module 111 to which the connection member 190 is coupled. The chassis module 111 may form a portion of the body 110 or may be coupled to a base of the body 110. For example, it may be understood that FIG. 1 illustrates the vehicle 100 in which the chassis module 111 illustrated in FIG. 2 is disposed inside the body 110 and the connection member 190 is coupled to the chassis module 111.

The connection member 190 may be coupled to the chassis module 111. For example, the connection members 190 to which two steering devices 130 are coupled may be coupled to both sides of the chassis module 111, respectively. Two wheels 120 may be coupled to two steering devices 130, respectively.

The body 110 of the vehicle 100 illustrated in FIG. 1 may be referred to as a floor portion. The chassis module 111 of FIG. 2 may be installed under the floor and not exposed to the outside. According to various embodiments, the vehicle 100 may have an interior space installed at an upper portion of the floor where a user may board or cargo may be loaded. Additionally, the interior space may be provided with seats, a steering wheel, and the like.

The body 110 may be provided with a wheel house 112, which is a predetermined space where the wheel 120 and the steering device 130 are mounted. The wheel house 112 may be formed in a size that may secure the steering angle of the wheel 120 up to about 90°. For example, the wheel house 112 requires a separation space corresponding to a diameter of a tire 122 in a width direction (e.g., minor direction of the vehicle 100 in FIG. 1) in which the steering device 130 extends in order for the wheel 120 to rotate at a steering angle of about 90°.

According to an embodiment in the present disclosure, a space of the wheel house 112 designed to steer the wheel 120 about 90° may be used as a space in which the steering device 130 is disposed. Thus, the steering device 130 may be installed substantially parallel to the body 110 without protruding above the wheel 120.

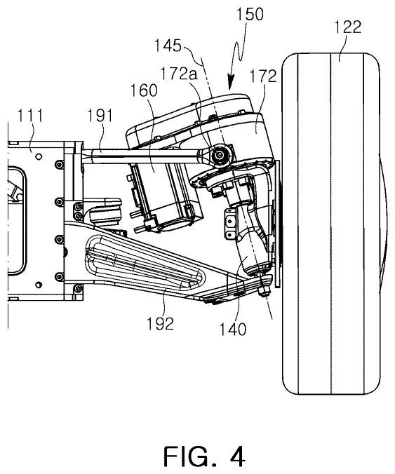

The wheel 120 may be coupled to the steering device 130. The wheel 120 may be provided in plural numbers, and the steering device 130 may be provided to correspond to the plurality of wheels 120. For example, the plurality of wheels 120 may be coupled to the corresponding steering devices 130, respectively, and may rotate around a kingpin shaft (e.g., kingpin shaft 145 in FIG. 4) by the operation of the steering device 130.

The wheel 120 may be composed of four wheels, including two front wheels 120a and two rear wheels 120b. The front and rear, which distinguish the front wheels 120a and the rear wheels 120b, are relative directions, and are not limited to the case where a direction in which the front wheels 120a are disposed is the front of the vehicle 100, and a direction in which the rear wheels 120b are disposed is the rear of the vehicle 100. For example, the two front wheels 120a may be connected to two first steering devices 130a, respectively, and the two rear wheels 120b may be connected to two second steering device 130b, respectively.

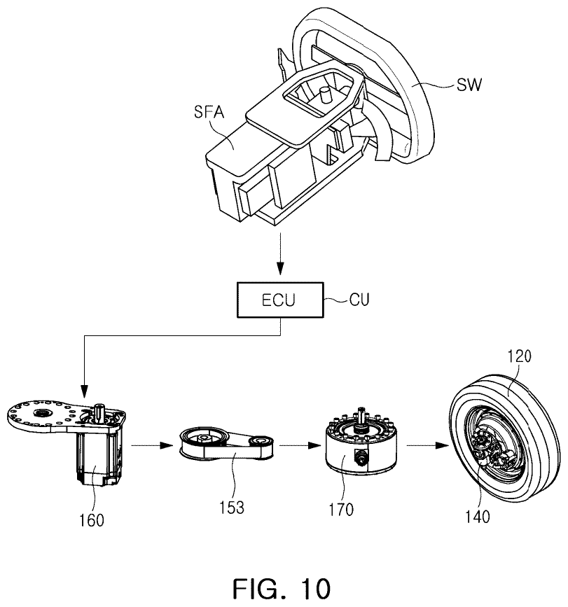

The steering device 130 may be provided to adjust a rotation angle of the wheel 120 according to a traveling direction of the vehicle 100 without being mechanically connected to the steering wheel. The steering device 130 may independently control the steering for each of the plurality of wheel 120. For example, the steering device 130 may operate to rotate the wheel 120 based on a steering signal input through the steering wheel (e.g., steering wheel SW in FIG. 10).

According to the illustrated embodiment, the steering device 130 may be applied to the vehicle 100 provided with four wheels 120 and independently control the steering for the four wheels 120. However, the number of wheels 120 is not limited to four, and the steering device 130 may be applied to vehicles with less than four wheels 120 or vehicles with more than four wheels 120.

The steering device 130 may include the two first steering devices 130a to which the two front wheels 120a are respectively connected and two second steering devices 130b to which the two rear wheels 120b are respectively connected. According to the illustrated embodiment, the first steering device 130a and the second steering device 130b may have the same structure. However, this is an example, and the first steering device 130a and the second steering device 130b may have different structures. For example, referring to FIG. 1, the second steering device 130b may change to a device configured using a linear actuator.

The connection member 190 may connect the steering device 130 to the body 110 of the vehicle 100. For example, one side of the connection member 190 may be coupled to the chassis module 111 of the body 110, and the steering device 130 may be coupled to the other side, so the steering device 130 may be mounted on the body 110.

The connection member 190 may include a first connection member 191 and a second connection member 192. The first connection member 191 may be coupled to a reducer 170 of the steering device 130. The second connection member 192 may be coupled to a knuckle 140 of the steering device 130.

The first connection member 191 may connect the chassis module 111 and the reducer 170 at an upper portion of the second connection member 192. The second connection member 192 may connect the chassis module 111 and the knuckle 140 below the first connection member 191. For example, the first connection member 191 may be fixedly coupled to a portion of the chassis module 111 at a position adjacent to an upper surface (e.g., surface facing upward with respect to FIG. 2) of the chassis module 111. The second connection member 192 may be fixedly coupled to a portion of the chassis module 111 at a position adjacent to a lower surface (e.g., surface facing downward with respect to FIG. 2) of the chassis module 111.

The connection member 190 may support the steering device 130 and the wheel 120 using the first connection member 191 and the second connection member 192. As a result, the connection member 190 may implement a double wishbone suspension.

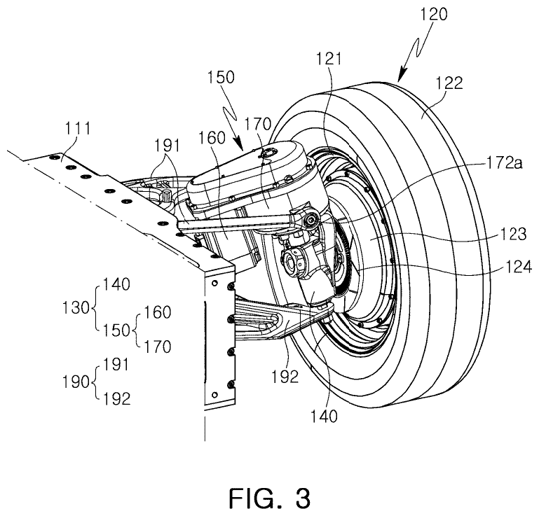

The structure in which the wheel 120, the steering device 130, and the connection member 190 are connected to the body 110 is described in more detail below with reference to FIGS. 3-5.

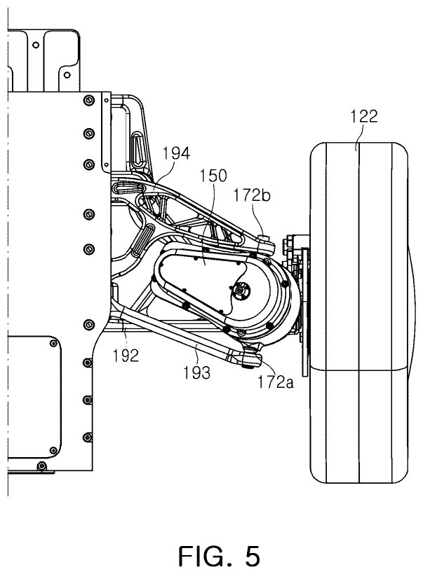

FIG. 3 is a perspective view illustrating a structure in which the wheel 120, the steering device 130, the connection member 190, and the body 110 of the vehicle 100 according to an embodiment in the present disclosure are connected. FIG. 4 is a front view illustrating the structure in which the wheel 120, the steering device 130, the connection member 190, and the body 110 of the vehicle 100 according to an embodiment in the present disclosure are connected. FIG. 5 is a top plan view illustrating the structure in which the wheel 120, the steering device 130, the connection member 190, and the body 110 of the vehicle 100 according to an embodiment in the present disclosure are connected.

FIG. 3 is an enlarged view of portion A illustrated in FIG. 2. FIG. 4 is a diagram illustrating the components illustrated in FIG. 3 when viewed from the front. FIG. 5 is a diagram illustrating the components illustrated in FIG. 3 when viewed from above.

Referring to FIGS. 3-5, the wheel 120 may be coupled to the steering device 130, the steering device 130 may be coupled to the connection member 190, and the connection member 190 may be connected to the chassis module 111. For example, the steering device 130 may be connected to the chassis module 111 through the connection member 190, and the wheel 120 may be connected to the chassis module 111 through the steering device 130.

An in-wheel motor driving method or an in-wheel system may be applied to each wheel 120 provided with the steering device 130 according to an embodiment in the present disclosure. In other words, the motor may be provided inside a wheel body 121 to independently provide driving force to each wheel 120, and the steering device 130 is provided for each wheel 120 to independently control the steering angle of the wheel 120.

The wheel 120 includes: a wheel body 121; the tire 122 disposed on the outside of the wheel body 121; an in-wheel motor 123 disposed inside the wheel body 121; and a brake disc 124 coupled to the in-wheel motor 123.

The in-wheel motor 123 is an electric motor mounted inside the wheel body 121 to directly drive the wheel body 121. The in-wheel motor 123 may be provided on each wheel 120 to independently drive and control the wheel 120. According to various embodiments, the in-wheel motor 123 may be referred to as a hub motor or an electric hub.

However, the illustrated embodiment is illustrative, and the embodiments of the present disclosure are not limited to the form in which the steering device 130 is provided on the vehicle (e.g., vehicle to which the in-wheel system is applied) to which the in-wheel motor 123 is applied. In the present disclosure, the vehicle to which the steering device 130 is applied includes vehicles provided with the general wheel 120 rather than the in-wheel system.

The steering device 130 may be disposed between the wheel 120 and the chassis module 111. The steering device 130 may include the knuckle 140 coupled to the wheel 120 and a driving unit 150 coupled to the knuckle 140.

The knuckle 140 may be coupled to the wheel 120 and rotate together with the wheel 120. For example, the wheel 120 may rotate by the rotation of the knuckle 140. The knuckle 140 may form the kingpin shaft 145, which is a shaft around which the wheel 120 rotates. The knuckle 140 may be coupled to a wheel shaft 123s of the wheel 120.

The knuckle 140 may be rotatably coupled to at least a portion of the driving unit 150. For example, the knuckle 140 may be coupled to the driving unit 150 and rotate with respect to the driving unit 150 by the driving force transmitted from the driving unit 150.

The knuckle 140 may be provided so that the driving unit 150 is coupled to an upper end portion and the second connection member 192 is coupled to a lower end portion. The knuckle 140 may be rotatably coupled to the second connection member 192. For example, when the knuckle 140 rotates due to the driving force of the driving unit 150, the knuckle 140 may rotate relatively with respect to the driving unit 150 and the second connection member 192.

The driving unit 150 may provide the driving force to rotate the wheel 120. For example, the driving unit 150 may control the direction of the wheel 120 connected to the rotational driving force to knuckle 140 by generating rotate the knuckle 140.

The driving unit 150 may include a motor 160 that provides the driving force and the reducer 170 that converts an output of the motor 160. The driving unit 150 may be configured so that when adjusting the rotation angle of the wheel 120, the reducer 170 and the motor 160 are fixed to the connection member 190 without rotating together with the wheel 120. For example, the motor 160 may be connected by the first connection member 191, and when the knuckle 140 and the wheel 120 rotate, a position of the motor 160 may be fixed with respect to the chassis module 111. In addition, for example, the reducer 170 may be connected by the first connection member 191, and when the knuckle 140 and the wheel 120 rotate, some components that transmit the rotational force to the knuckle 140 may rotate together with the knuckle 140, but a position of the reducer 170 itself may be fixed with respect to the chassis module 111.

The steering device 130 may be connected to the chassis module 111 (i.e., the body 110 of the vehicle 100) through the connection member 190. The driving unit 150 of the steering device 130 may be coupled to the first connection member 191. The knuckle 140 of the steering device 130 may be connected to the second connection member 192.

The driving unit 150 may include coupling portions 172a and 172b to which the first connection member 191 is coupled. The coupling portions 172a and 172b may include the first coupling portion 172a and the second coupling portion 172b provided on an opposite side of the first coupling portion 172a. For example, the first coupling portion 172a may be formed on a first direction (\textcircled{1}) (e.g., direction facing downward with respect to FIG. 5) side, and the second coupling portion 172b may be formed on a second direction (\textcircled{2}) (e.g., direction facing upward with respect to FIG. 5) side opposite to the first direction (\textcircled{1}).

Referring to FIG. 4, the driving unit 150 may be positioned lower than the wheel 120. For example, the driving unit 150 may not protrude above the wheel 120 but may be positioned within a diameter of the wheel 120.

The connection member 190 may include the first connection member 191 connecting the driving unit 150 of the steering device 130 to the chassis module 111 and the second connection member 192 connecting the knuckle 140 of the steering device 130 to the chassis module 111.

The first connection member 191 may include a first connecting part 193 that is coupled to one side of the driving unit 150 and a second connecting part 194 that is coupled to the other side of the driving unit 150. For example, the first connection part 193 may be configured so that one end portion is fixed to the chassis module 111 and the other end portion is coupled to the first coupling portion 172a provided in the driving unit 150. The second connection part 194 may be configured so that one end portion is fixed to the chassis module 111 and the other end portion is coupled to the second coupling portion 172b provided in the driving unit 150. The first connection member 191 may have a structure in which the first connection part 193 and the second connection part 194 are formed integrally, or may be configured to have a separate component in which the first connection part 193 and the second connection part 194 are separated from each other.

The second connection member 192 may be coupled to the lower end portion of the knuckle 140. The second connection member 192 may be rotatably coupled to the lower end portion of the knuckle 140. As illustrated in FIG. 4, when the steering device 130 and the connection member 190 are viewed from the front, the knuckle 140 may be positioned between the first connection member 191 and the second connection member 192.

The connection member 190 may support the steering device 130 and the wheel 120 through the first connection member 191 disposed at an upper portion and the second connection member 192 disposed at a lower portion, thereby providing the double wishbone suspension structure. For example, the first connection part 193 of the first connection member 191 may be referred to as an upper link. The second connection part 194 of the first connection member 191 may be referred to as an upper arm. Additionally, the second connection member 192 may be referred to as a lower arm.

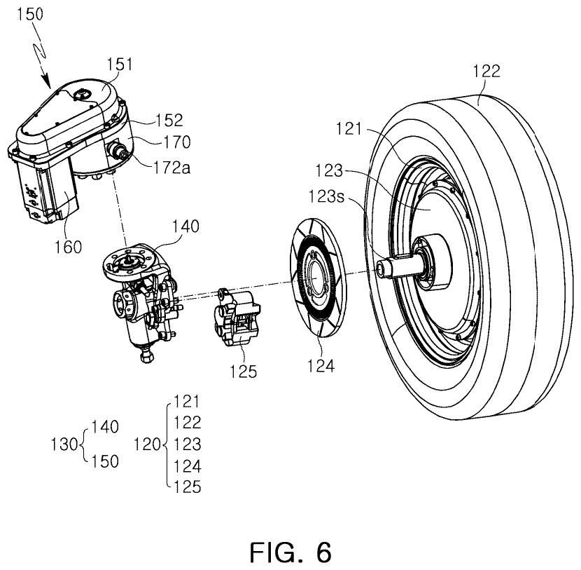

FIG. 6 is a perspective view illustrating the state in which the steering device 130 according to an embodiment in the present disclosure is disassembled from the wheel 120.

FIG. 6 illustrates a state in which the brake disc 124 is separated from the wheel 120, a braking device 125 is separated from the brake disc 124, and the steering device 130 separated from the wheel 120 is disassembled into the knuckle 140 and the driving unit 150.

Referring to FIG. 6, the vehicle 100 according to an embodiment may include the wheel 120 and the steering device 130. The vehicle wheel 120 may include the wheel body 121, the tire 122, the in-wheel motor 123, the brake disc 124, and the braking device 125. The steering device 130 may include the knuckle 140 and the driving unit 150.

The wheel 120 may be configured in an assembly in which the tire 122 is mounted on the external side of the wheel body 121, the in-wheel motor 123 is mounted on an inner side of the wheel body 121, the brake disc 124 is coupled to the in-wheel motor 123, and the braking device 125 is connected to the brake disc 124. As described above, embodiments of the present disclosure are not limited to the wheel 120 on which the in-wheel motor 123 is mounted.

The braking device 125 may apply braking force to the wheel 120 by limiting the rotation of the brake disc 124. A portion of the braking device 125 may be coupled and fixed to the knuckle 140, and another portion may be connected to the brake disc 124 to apply the braking force to the brake disc 124 through friction caused by contact with the brake disc.

The knuckle 140 may be coupled to the wheel 120. For example, the knuckle 140 may be coupled to the wheel shaft 123s of the wheel 120. The knuckle 140 may be fixed by being fitted into the wheel shaft 123s. The wheel shaft 123s may become a center of rotation of the wheel body 121 and tires 122 when the vehicle 100 is driven. For example, the in-wheel motor 123 may be rotatably fitted to the wheel shaft 123s, and the knuckle 140 may be fixed to the wheel shaft 123s. In other words, when the wheel 120 rotates to move the vehicle 100, the in-wheel motor 123, the wheel body 121, the tire 122, and the brake disc 124 may rotate around the wheel shaft 123s, and the knuckle 140 and the wheel shaft 123s may be separated from the rotation of the in-wheel motor 123 and thus not rotate.

The knuckle 140 may connect the driving unit 150 and the wheel 120 and transmit the driving force provided from the driving unit 150 to the wheel 120 to rotate the wheel 120. For example, the knuckle 140 may rotate relatively with respect to the driving unit 150 and may rotate integrally with the wheel 120. Accordingly, when the knuckle 140 rotates with respect to the driving unit 150 by the driving force of the driving unit 150, the wheel 120 may rotate together with the knuckle 140 to achieve the steering.

The knuckle 140 may be coupled to the reducer 170 of the driving unit 150. The knuckle 140 may rotate together with some components (e.g., output unit 174) inside the reducer 170, but may rotate relatively with respect to the remaining components of the reducer 170.

The knuckle 140 may support the braking device 125 and a wheel speed sensor (not illustrated). For example, a portion of the braking device 125 connected to the brake disc 124 may be coupled to the knuckle 140. The wheel speed sensor may be coupled to the knuckle 140. The wheel speed sensor may be coupled to the knuckle 140 and detect a rotation speed of the wheel 120 according to the driving of the vehicle 100.

The driving unit 150 may be coupled to the knuckle 140 and provide the driving force for the rotation of the knuckle 140. The driving unit 150 may include the motor 160, the reducer 170, a bracket 152, and a cover 151.

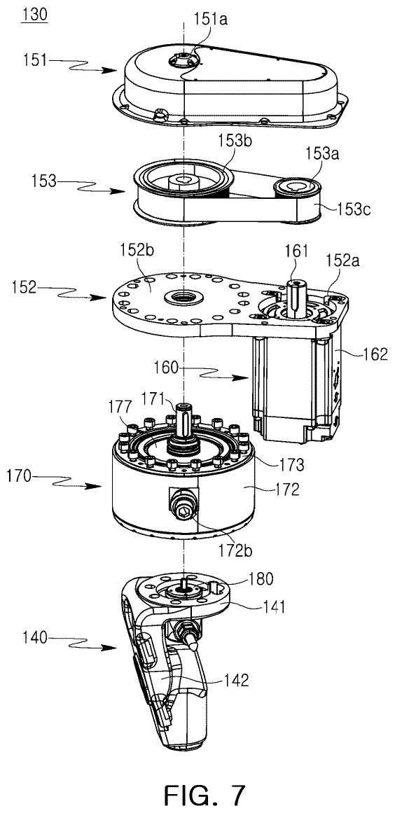

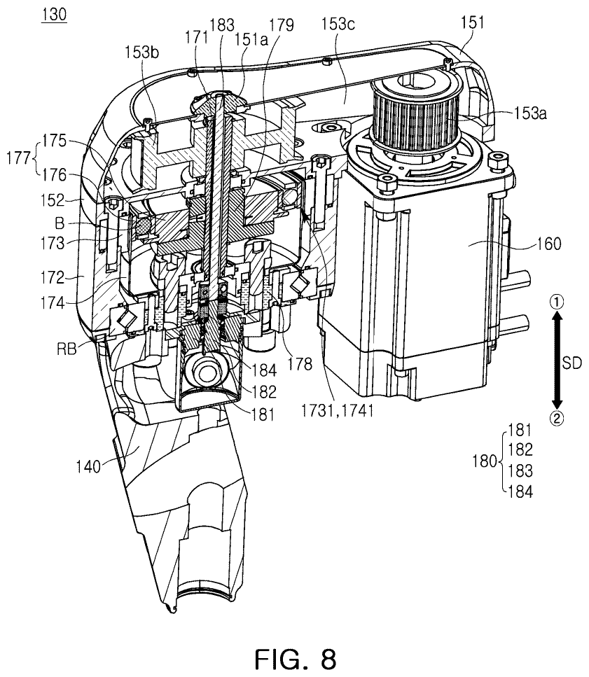

An external side surface of the reducer 170 may be provided with the coupling portions 172a and 172b to which the first connection member 191 is coupled. The coupling portions 172a and 172b may protrude from the external side surface of the reducer 170. The external side surface of the reducer 170 refers to an external surface of a housing (e.g., housing 172 in FIGS. 7 and 8) of the reducer 170.

The specific configuration of the driving unit 150 is described in more detail below with reference to FIGS. 7 and 8.

FIG. 7 is an exploded perspective view illustrating the state in which the steering 130 device according to an embodiment in the present disclosure is disassembled. FIG. 8 is a cross-sectional perspective view illustrating the state in which the steering 130 device according to an embodiment in the present disclosure is coupled.

FIGS. 7 and 8 are exploded perspective and cross-sectional perspective views of the steering device 130 illustrated in FIGS. 1-6. In describing FIGS. 7 and 8, FIGS. 1-6 are referred to together, and overlapping descriptions have been omitted below.

Referring to FIGS. 7 and 8, the steering device 130 according to an embodiment may include the knuckle 140 and the driving unit 150 coupled to the knuckle 140.

The knuckle 140 may include a first coupling portion 141 to which the driving unit 150 is coupled and a second coupling portion 142 to which the wheel 120 is coupled. The second coupling portion 142 may extend downward from the first coupling portion 141. The first coupling portion 141 may be coupled to the reducer 170 of the driving unit 150. The wheel shaft 123s may at least partially penetrate through the second coupling portion 142, so the second coupling portion 142 may be coupled to the wheel 120.

The knuckle 140 may be connected to the output unit 174 of the reducer 170 and may rotate by the rotation of the output unit 174. The knuckle 140 may rotate relatively with respect to the housing 172 and the motor 160 of the reducer 170. For example, the knuckle 140 may rotate together with the output unit 174 when the output unit 174 rotates. Additionally, when the knuckle 140 rotates, the housing 172 and the motor 160 of the reducer 170 may remain fixed without rotating.

A rotary encoder 180 for measuring the steering angle of the wheel 120 may be disposed on the knuckle 140.

The driving unit 150 may include the motor 160, the reducer 170, the bracket 152, a power transmission member 153, and the cover 151. The driving unit 150 may arrange the motor 160 and the reducer 170 in parallel and transmit the power of the motor 160 to the reducer 170 through the power transmission member 153. As a result, the configuration reduces a shaft direction (SD) length of the driving unit 150.

The motor 160 may provide the driving force for the rotation of the knuckle 140. The motor 160 may be a servomotor, but is not limited thereto. The rotation direction and/or rotation speed of the motor 160 may be controlled by a control unit (not illustrated) (e.g., control unit (CU) of FIG. 10).

The motor 160 may be coupled to and fixed to the bracket 152. The motor 160 may be coupled to a first part 152a of the bracket 152. The motor 160 is coupled to a lower surface of the bracket 152, and a first rotating shaft 161 of the motor 160 may penetrate through the bracket 152 and be positioned at an upper portion of the bracket 152. The lower surface of the bracket 152 is a surface facing the second direction (\textcircled{2}) where the knuckle 140 is positioned, and an upper surface is an opposite side of the lower surface and is a surface facing the first direction (\textcircled{1}) where the cover 151 is positioned.

The motor 160 may be coupled to the power transmission member 153. For example, the first rotating shaft 161 of the motor 160 may be coupled to the power transmission member 153, and the rotation of the first rotating shaft 161 may be transmitted to the reducer 170 through the power transmission member 153.

The reducer 170 may convert the driving force provided from the motor 160 into a torque required for steering the wheel 120. For example, the reducer 170 may implement the rotation of the knuckle 140 by transmitting the rotational force transmitted from the motor 160 to the knuckle 140.

The reducer 170 may be fixed by being coupled to the bracket 152. The reducer 170 may be coupled to a second part 152b of the bracket 152 of the motor 160. The reducer 170 may be coupled to the lower surface of the bracket 152. The second rotating shaft 171 of the reducer 170 may penetrate through the bracket 152 and may be positioned at the upper portion of the bracket 152.

The reducer 170 may be coupled to the power transmission member 153 to receive the rotational force of the motor 160. For example, the second rotating shaft 171 of the reducer 170 may be coupled to the power transmission member 153. The second rotating shaft 171 may transmit the rotational force of the first rotating shaft 161 through the power transmission member 153.

The bracket 152 may be configured to be coupled to the motor 160 and the reducer 170 in the state in which each of the rotating shafts 161 and 171 is positioned parallel to each other. For example, the motor 160 and the reducer 170 may be coupled to the bracket 152 so that the first and second rotating shafts 161 and 171 are disposed in parallel with a certain distance apart. The motor 160 and the reducer 170 may be coupled to the bracket 152 through various coupling means.

The bracket 152 is formed in a shape of a plate having a predetermined size. The motor 160 and the reducer 170 may be coupled to the lower surface of the bracket 152 and may be coupled to different parts. The bracket 152 may include the first part 152a to which the motor 160 is coupled, and the second part 152b extending from the first part 152a to which the reducer 170 is coupled. The bracket 152 may have a structure in which the first part 152a and the second part 152b are integrally formed. The first part 152a and the second part 152b are not physically separated or separated parts. It should be understood that the entire bracket 152 is intended to separately refer to the part to which the motor 160 is coupled and the part to which the reducer 170 is coupled.

The bracket 152 may have through holes through which the first rotating shaft 161 of the motor 160 and the second rotating shaft 171 of the reducer 170 penetrate, respectively. For example, a main body 162 of the motor 160 and the housing 172 of the reducer 170 are each fixedly coupled to the lower surface of the bracket 152. The first rotating shaft 161 of the motor 160 and the rotating shaft 171 of the reducer 170 may be positioned on the upper surface of the bracket 152 through each corresponding through hole.

The first rotating shaft 161 of the motor 160 and the second rotating shaft 171 of the reducer 170 may be disposed on the upper surface of the bracket 152. The power transmission member 153 may be connected to the first rotating shaft 161 and the second rotating shaft 171.

The power transmission member 153 may be provided to transmit the rotational motion of the first rotating shaft 161 of the motor 160 to the second rotating shaft 171 of the reducer 170 to rotate the second rotating shaft 171. The power transmission member 153 may be coupled to the first rotating shaft 161 and the second rotating shaft 171 on the upper surface of the bracket 152.

The power transmission member 153 is a component for transmitting the rotational motion by connecting the first rotating shaft 161 of the motor 160 and the second rotating shaft 171 of the reducer 170, which are disposed in parallel. Additionally, by providing the power transmission member 153, it may be possible to have a structure in which the motor 160 and the reducer 170 are separated and disposed in parallel.

The power transmission member 153 may include a first pulley 153a that is coupled to the first rotating shaft 161, a second pulley 153b that is coupled to the second rotating shaft 171, and a belt 153c connecting the first pulley 153a and the second pulley 153b. For example, when the first pulley 153a may rotate due to the rotation of the first rotating shaft 161, the rotation of the first pulley 153a may be transmitted to the second pulley 153b through the belt 153c. The second rotating shaft 171 may rotate by the rotation of the second pulley 153b. The power transmission member 153 may provide primary deceleration before deceleration by the reducer 170 while transmitting the power of the rotational motion.

The type, shape and/or structure of the power transmission member 153 is not limited to the illustrated embodiment, and may be varied within a range capable of transmitting the rotational motion of the first rotating shaft 161 to the second rotating shaft 171. According to various embodiments, the power transmission member 153 may be implemented using gears or chains.

The cover 151 may be coupled to the upper surface of the bracket 152. The cover 151 may be coupled to the upper surface of the bracket 152 and cover the first rotating shaft 161, the second rotating shaft 171, and the power transmission member 153 that are positioned on the upper surface of the bracket 152. The cover 151 may have a predetermined space inside where the first rotating shaft shaft 171, and the power 161, the second rotating transmission member 153 may be accommodated.

According to various embodiments, the assembly in which the cover 151 and the bracket 152 are coupled to each other may be referred to as a support member supporting a driving system including the motor 160, the reducer 170, and the power transmission member 153.

Referring to FIG. 8, the reducer 170 may be implemented using a harmonic drive reducer. Hereinafter, the components of the harmonic drive reducer are described. However, the harmonic drive reducer is illustrative, and in an embodiment in the present disclosure, the reducer 170 is not necessarily limited to the harmonic drive reducer, and various types of reducers may be used.

The reducer 170 may include the housing 172, an input unit 177, the output unit 174, and a fixing portion 173.

The housing 172 may be formed in a cylindrical shape, and the input unit 177, the fixing portion 173, and the output unit 174 may be disposed therein. The housing 172 may be coupled to the bracket 152. The housing 172 may form at least portion of an exterior of the reducer 170. The input unit 177 may include an inner ring 175 that is connected to the second rotating shaft 171 of the reducer 170 and formed of an oval. The input unit 177 may also include an external ring 176 that is elastically deformed to protrude in a major axis direction as the inner ring 175 rotates via a plurality of balls B on an external side of the inner ring 175. The input unit 177 may be referred to as a wave generator of the harmonic drive reducer.

The inner ring 175 has a substantially thin elliptical pillar shape and may rotate by receiving the rotational force of the second rotating shaft 171. A ball B of the plurality of balls B outside the inner ring 175 may perform a rolling contact motion inside the external ring 176 according to the rotation of the inner ring 175. In this case, the external ring 176 may be formed in a ring shape with elasticity so that it protrudes in the major axis direction of the inner ring 175 and retracts in a minor axis direction thereof.

The input unit 177 may be connected to the second rotating shaft 171 to rotate by the rotation of the second rotating shaft 171. The input unit 177 may be connected to receive the rotational motion of the second rotating shaft 171 through a coupling member 179. For example, the coupling member 179 may be inserted into the inner ring 175 of the input unit 177 and the coupling member 179 may be connected to the second rotating shaft 171. Accordingly, when the second rotating shaft 171 rotates by receiving the rotational force of the first rotating shaft 161, the inner ring 175 of the input unit 177 connected to the second rotating shaft 171 via the coupling member 179 may rotate together. The inner ring 175 may rotate around the second rotating shaft 171. According to various embodiments, the coupling member 179 may include the pulley, but is not limited thereto.

The output unit 174 has a hollow cylindrical shape, and may have a shape such as a container in which one side is open and the other side is closed. The input unit 177 is coupled to an inner peripheral surface of one side of the output unit 174. The output unit 174 may have an area of one end portion facing the external ring 176 of the input unit 177 elastically deformed in response to the elastic deformation of the external ring 176 of the input unit 177. One side refers to the first direction (\textcircled{1}) facing toward the side where the cover 151 is disposed among the directions parallel to the shaft direction (SD), and the other side refers to the second direction (\textcircled{2}) facing the opposite side to the first direction (\textcircled{1}) and facing the side where the knuckle 140 is disposed. The output unit 174 may be referred to as a flex spline of the harmonic drive reducer.

The coupling member 179 may be disposed inside the output unit 174 while being coupled to the input unit 177. External teeth 1741 may be provided on an external peripheral surface of one side of the output unit 174. The external teeth 1741 of the output unit 174 may be formed to partially engage with internal teeth 1731 of the fixing portion 173.

The output unit 174 may be connected to the knuckle 140 and rotate together with the knuckle 140. For example, the other side of the output unit 174 may be connected to the knuckle 140. The other side of the output unit 174 may be connected to the knuckle 140 through a fixing member 178, and the rotational motion of the output unit 174 may be transmitted to the knuckle 140. For example, the other side of the output unit 174 may be coupled to the fixing member 178, and the fixing member 178 may be coupled to the knuckle 140. In various embodiments, the fixing member 178 may be referred to as a bush structure.

The output unit 174 may rotate around the second rotating shaft 171 together with the knuckle 140. For example, the kingpin shaft (e.g., kingpin shaft 145 in FIG. 4), which is the rotation center of the knuckle 140, may pass through the center of the second rotating shaft 171. The kingpin shaft 145 may be parallel to the first rotating shaft 161 of the motor 160. The output unit 174 may rotate 360°, so it is possible to implement a steering angle of 90° or more.

A roller bearing (RB) may be disposed between the fixing member 178 and the housing 172. For example, the roller bearing (RB) may be provided between an inner peripheral surface of the other side of the housing 172 and an external peripheral surface of the fixing member 178. The fixing member 178 connected to the output unit 174 may output deceleration rotational force while rotating inside the roller bearing RB, and the knuckle 140 may rotate by the deceleration rotational force.

The fixing portion 173 may be disposed to surround a portion of the external peripheral surface of the output unit 174 where the external teeth 1741 are formed. The fixing portion 173 may have internal teeth 1731 formed on one side of the inner peripheral surface at a position corresponding to the external teeth 1741 of the output unit 174. The fixing portion 173 may be referred to as a circular spline of the harmonic drive reducer. The number of internal teeth 1731 formed on the fixing portion 173 may be greater than the external teeth 1741 formed on the output unit 174.

The fixing portion 173 may be coupled and fixed to the housing 172. For example, the fixing portion 173 may be fixed to the housing 172 and the bracket 152 through a bolting coupling. Additionally, when the second rotating shaft 171 and the input unit 177 rotate, the fixing portion 173 and housing 172 may be fixed to the bracket 152 and not rotate.

The reducer 170 may transmit the rotational motion of the first rotating shaft 161 to the second rotating shaft 171 through the power transmission member 153. When the input unit 177 rotates due to the rotation of the second rotating shaft 171, the output unit 174 may be elastically deformed into an oval shape, and the external teeth 1741 of the output unit 174 may rotate relatively with respect to the fixed fixing portion 173 while engaging with the internal teeth 1731 of the fixing portion 173 in the major axis direction.

The rotational force of the second rotating shaft 171 may be primarily decelerated by the power transmission member 153 and then secondarily decelerated by the reducer 170. The decelerated rotational force may be transmitted to the knuckle 140 through the output unit 174 and the fixing member 178. The reduction ratio of the fixing portion 173 and the output unit 174 may be in the range of approximately 20:1 to 200:1. More preferably, the reduction ratio may be approximately 100:1, but is not limited thereto.

Since the harmonic drive reducer is a well-known technology in the relevant technical field, a detailed description of the detailed configuration and deceleration operation of the harmonic drive reducer have been omitted.

The driving unit 150 of the steering device 130 according to an embodiment may transmit the rotational force of the first rotating shaft 161 according to the operation of the motor 160 to the second rotating shaft 171 of the reducer 170 through the power transmission member 153. Additionally, the motor 160 may be driven to rotate the knuckle 140 coupled to the output unit 174 as the output unit 174 rotates by rotation of the second rotating shaft 171. In this case, the motor 160 and the housing 172 of the reducer 170 may be separated from the rotation of the knuckle 140 and remain fixed to the bracket 152. As the housing 172 of the reducer 170 is coupled to the body 110 through the first connection member 191, the relative position and attitude of the driving unit 150 with respect to the body 110 may be fixed independent of the rotation of the knuckle 140. The reducer 170 may be configured so that when the knuckle 140 rotates, the housing 172 may be fixed to the bracket 152 and not rotate. The input unit 177, the output unit 174, the fixing member 178, the coupling member 179, or the second rotation axis 171, which are some of the components disposed inside the housing 172, may rotate relatively with respect to the housing 172. In other words, even when the relative positions and attitudes of the knuckle 140 and the wheel 120 with respect to the body 110 change by the rotation of the knuckle 140, the positions and attitudes of the motor 160 and the reducer 170 with respect to the body 110 may be maintained, and some components may rotate inside the housing 172 of the reducer 170.

The driving unit 150 of the steering device 130 according to an embodiment may be configured to be disposed in parallel by coupling the motor 160 and the reducer 170 to different areas (e.g., first part 152a and second part 152b) on one surface (e.g., lower surface facing the second direction (\textcircled{2}) of the plate-shaped bracket 152. The motor 160 and the reducer 170 may be coupled to the bracket 152 in the form that each of the rotating shafts 161 and 171 penetrate through the bracket 152 and protrude from the other side (e.g., upper surface facing the first direction (\textcircled{1})) of the bracket 152, but is disposed in parallel at regular intervals.

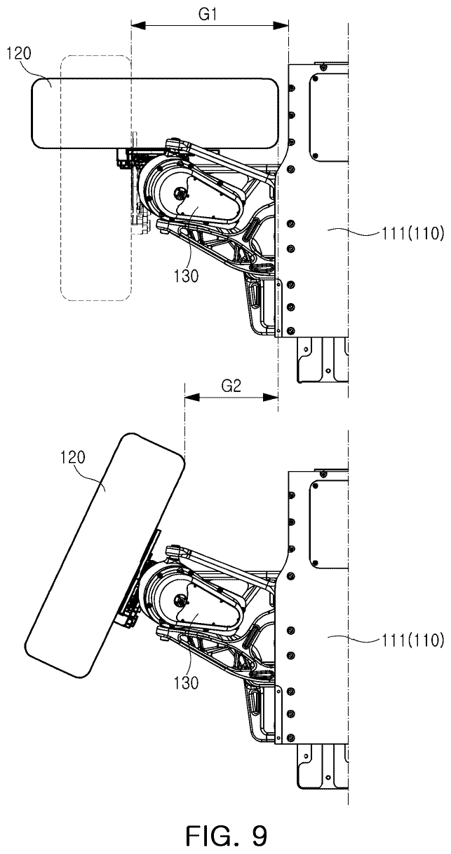

FIG. 9 is a diagram illustrating an operation in which the wheel 120 rotates by the steering device 130 in the vehicle 100 according to an embodiment in the present disclosure.

Referring to FIG. 9, the steering device 130 according to an embodiment may rotate the wheel 120 with respect to the body 110. The steering device 130 may steer the wheel 120 about 90° or more. In the steering operation, the driving unit 150 of the steering device 130 may be fixed to the body 110 and the knuckle 140 may rotate with respect to the body 110 to rotate the wheel 120.

As described above, in order to secure the steering angle of the wheel 120 up to 90°, the wheel house 112 having a size that may not contact the body 110 while the wheel 120 rotates 90° is desired. For example, comparing the upper and lower drawings of FIG. 9, as the steering angle of the wheel 120 is desired to be up to 90°, compared to the case where the wheel 120 rotates about 40° to 50°, an additional gap G2 is desired in the wheel house 112.

As illustrated in FIG. 9, in the vehicle 100 according to an embodiment, the wheel 120 and the body 110 may be spaced apart from each other at a predetermined gap G1 while the wheel 120 does not rotate, and the predetermined gap G1 may be used as a space where at least 5 a portion of the wheel 120 is positioned when the wheel 120 is rotated 90°. For example, the predetermined gap G1 between the wheel 120 and the body 110 may be smaller than the diameter of the wheel 120 and larger than a radius of the wheel 120. The steering device 130 may be mounted in the space formed by the gap G1 between the wheel 120 and the body 110.

Referring to FIG. 4 together, the steering device 130 according to an embodiment may be mounted in the space between the wheel 120 and the body 110, and have a compact structure that may reduce the shaft direction (SD) length of the driving unit 150 by arranging the motor 160 and the reducer 170 of the driving unit 150 in parallel. As a result, the driving unit 150 does not protrude above the wheel 120 or is positioned higher than the wheel 120. Accordingly, since other parts or mechanisms are not positioned above the wheel 120, it may be easy to apply the low-floor platform.

FIG. 10 is a diagram schematically illustrating a system for controlling a steering device 130 of a vehicle 100 according to an embodiment in the present disclosure.

Referring to FIG. 10, a vehicle (e.g., vehicle 100 in FIG. 1) according to an embodiment in the present disclosure may include the wheel 120, the steering device 130, a steering wheel (SW), and a control unit (CU). The steering device 130 may include the motor 160, the power transmission member 153, the reducer 170, and the knuckle 140. For example, the vehicle 100 according to an embodiment may include a steer-by-wire (SbW) system.

The steering device 130 and the wheel 120 of the vehicle 100 illustrated in FIG. 10 have been described above with reference to FIGS. 1-8, and redundant description have been omitted below. In describing FIG. 10, FIGS. 1-8 are referred to together.

The steering wheel (SW) may receive a driver's input signal for steering the wheel 120. The driver's input signal may include the steering angle and torque of the wheel 120. The steering wheel (SW) may transmit the driver's input signal to the control unit (CU). The steering wheel (SW) may be connected to an actuator (steering feedback actuator (SFA)) that provides reaction force of the steering wheel to the driver.

The control unit (CU) may generate the control signal for driving the motor 160 based on the input signal input to the steering wheel (SW). The control unit (CU) may then transmit the generated control signal to the motor 160 to operate the motor 160 to rotate the wheel 120 by the steering angle included in the input signal.

The control unit (CU) may be referred to as an electronic control unit (ECU), and the control unit (CU) may include at least one of a vehicle platform computer (VPC), a front zone unit (FZU), and a motor drive.

The motor 160 may be driven by the control unit (CU). The motor 160 may generate the driving force for steering the wheel 120 by rotating in a predetermined direction based on the control signal from the control unit CU.

The rotational motion of the motor 160 may be transmitted to the reducer 170 through the power transmission member 153. In this case, the primary deceleration may be made while the rotational motion is transmitted through the power transmission member 153.

The rotational motion of the motor 160 may be output through the output unit 174 of the reducer 170 while being secondarily decelerated in the reducer 170. Additionally, as the knuckle 140 coupled to the output unit 174 rotates, the wheel 120 may rotate.

According to an embodiment in the present disclosure, by arranging the motor and the reducer in parallel, it is possible to shorten the length of the steering device, design the steering device so that the steering device does not protrude above the tire, and fix the position of the motor when steering the wheels.

In addition, according to an embodiment in the present disclosure, by positioning the steering device between the vehicle body and the wheels to expose the steering device to the outside, it is possible to improve the heat dissipation performance of the driving unit.

In addition, according to an embodiment in the present disclosure, it is possible to perform the reduction in addition to the reduction by the reducer by transmitting power between the motor and the reducer through the power transmission member, and to easily adjust the reduction ratio by changing the design of the power transmission member.

In addition, according to an embodiment in the present disclosure, it is possible to compactly configure the driving unit by applying the harmonic drive reducer.

While the embodiments have been illustrated and described above, it should be apparent to those having ordinary skill in the art that modifications and variations could be made without departing from the scope of the present disclosure as defined by the appended claims.

In addition, embodiments of the present disclosure may be implemented with some components deleted. The components of each embodiment may also be configured in combination with each other.

What is claimed is:

1. An independent steering device, comprising:
a knuckle coupled to a wheel; and
a driving unit having the knuckle rotatably coupled to at least a portion thereof and providing a driving force for rotating the knuckle,
wherein the driving unit includes:
a motor including a first rotating shaft,
a reducer including a second rotating shaft and is coupled to the knuckle, and
a power transmission member connecting the first rotating shaft and the second rotating shaft and configured to transmit a rotational force between the first rotating shaft and the second rotating shaft, and
wherein the motor and the reducer are disposed so that the first rotating shaft and the second rotating shaft are parallel.

2. The independent steering device of claim 1, wherein the driving unit further includes a bracket to which the motor and the reducer are coupled, and
wherein the bracket includes a first part to which the motor is coupled and a second part extending from the first part and coupled to the reducer.

3. The independent steering device of claim 2, wherein the motor and the reducer are coupled to a lower surface of the bracket,
wherein the first rotating shaft and the second rotating shaft penetrate through the bracket and are positioned on an upper surface of the bracket, and
wherein the power transmission member is connected to the first rotating shaft and the second rotating shaft on the upper surface of the bracket.

4. The independent steering device of claim 3, wherein the bracket is formed in a plate shape, and
wherein the first rotating shaft and the second rotating shaft respectively protrude from the upper surface of the bracket by a predetermined length and are disposed in parallel at a predetermined distance.

5. The independent steering device of claim 1, wherein the power transmission member includes a first pulley that is coupled to the first rotating shaft, a second pulley that is coupled to the second rotating shaft, and a belt connecting the first pulley and the second pulley, and
wherein a rotational motion of the first rotating shaft is decelerated at a predetermined reduction ratio by the power transmission member.

6. The independent steering device of claim 2, wherein the reducer further includes a housing that is fixed to the bracket, and an output unit that is at least partially disposed inside the housing and rotates with respect to the housing in conjunction with rotation of the second rotating shaft, and
wherein the knuckle is connected to the output unit so as to rotate integrally with the output unit.

7. The independent steering device of claim 6, wherein the reducer decelerates a rotational motion of the second rotating shaft at a predetermined reduction ratio and outputs the rotational motion through the output unit.

8. The independent steering device of claim 6, wherein the knuckle relatively rotates with respect to the housing of the reducer, and
wherein when the knuckle rotates, positions of the housing, the motor, and the bracket of the reducer are fixed.

9. The independent steering device of claim 6, wherein the reducer is a harmonic drive reducer.

10. The independent steering device of claim 9, wherein the reducer further includes:
an input unit including:
an inner ring connected to the second rotating shaft and formed of an oval, and
an external ring elastically deformed to protrude in a major axis direction by rotation of the inner ring via a plurality of balls provided on an external side of the inner ring; and
a fixing portion fixed to the bracket together with the housing and provided with internal teeth formed on an inner side surface thereof, wherein the output unit is inserted into the fixing portion, and
wherein the input unit is coupled to an inner side of the output unit, and the output unit is provided with external teeth formed on an external side surface thereof and configured to be elastically deformed based on deformation of the external ring of the input unit, wherein the external teeth of the output unit correspond to the internal teeth of the fixing portion.

11. The independent steering device of claim 1, wherein the driving unit is coupled to a vehicle body through a connection member, and
wherein the reducer includes a coupling portion, formed on an external side surface of the reducer and is configured to be coupled to the connection member.

12. A vehicle, comprising:
a vehicle body;
a wheel mounted on the vehicle body; and
a steering device connecting the vehicle body and the wheel, and configured to steer the wheel,
wherein the steering device includes
a knuckle coupled to a wheel and
a driving unit having the knuckle rotatably coupled to at least a portion thereof and providing a driving force for rotating the knuckle,
wherein the driving unit includes:
a motor including a first rotating shaft,
a reducer including a second rotating shaft that is coupled to the knuckle, and
a power transmission member connecting the first rotating shaft and the second rotating shaft and configured to transmit a rotational force between the first rotating shaft and the second rotating shaft, and
wherein the motor and the reducer are disposed so that the first rotating shaft and the second rotating shaft are parallel.

13. The vehicle of claim 12, further comprising:
a connection member connecting the steering device and the vehicle body,
wherein the connection member includes a first connection member connecting the reducer and the vehicle body and a second connection member connecting the knuckle and the vehicle body, and
wherein the first connection member is positioned above the second connection member.

14. The vehicle of claim 13, wherein an upper end portion of the knuckle is coupled to the reducer,
wherein a lower end portion of the knuckle is coupled to the second connection member, and
wherein the second connection member is rotatably coupled to the lower end portion of the knuckle.

15. The vehicle of claim 13, wherein the reducer includes a coupling portion, formed on an external side surface of the reducer, and is configured to be coupled to the second connection member.

16. The vehicle of claim 13, wherein as the reducer is coupled to the vehicle body through the second connection member, a relative position and attitude of the driving unit with respect to the vehicle body are fixed when the knuckle rotates.

17. The vehicle of claim 12, wherein a gap is formed between the wheel and the vehicle body to secure a steering angle of the wheel to a predetermined angle, and
wherein the steering device is provided in a space formed by the gap to be positioned between the wheel and the vehicle body.

18. The vehicle of claim 12, wherein the driving unit further includes a bracket to which the motor and the reducer are coupled, and
wherein the bracket includes a first part to which the motor is coupled and a second part extending from the first part and coupled to the reducer.

19. The vehicle of claim 18, wherein the motor and the reducer are coupled to a lower surface of the bracket,
wherein the first rotating shaft and the second rotating shaft penetrate through the bracket and are positioned on an upper surface of the bracket, and
wherein the power transmission member is connected to the first rotating shaft and the second rotating shaft on the upper surface of the bracket.

20. The vehicle of claim 12, wherein the reducer is a harmonic drive reducer.
